(19) United States
(12) Patent Application Publication
(10) Pub. No.: US 2003/0129915 A1
(43) Pub. Date: Jul. 10, 2003

(54) Process for making a super absorbent polymer-impregnated non-woven absorbent core for personal hygiene products

(75) Inventor: John M. Harriz, Glen Mills, PA (US)

Correspondence Address: Kevin R. Casey, Ratner & Prestia, Suite 301, One Westlakes, Berwyn, P.O. Box 980, Valley Forge, PA, 19482-0980, US

(73) Assignee: Tyco Healthcare Retail Services AG

(21) Appl. No.: 10/039,029

(22) Filed: Jan. 4, 2002

(51) Int. Cl. D04H 1/00; D04H 3/00; D04H 5/00; D04H 13/00; B32B 5/16

(52) U.S. Cl. 442/417

(57) ABSTRACT

A process is provided for forming a super absorbent composite for use in personal hygiene products, comprising a non-woven core with SAP uniformly distributed throughout the thickness of the core and bonded to the core with an adhesive. A non-woven core is provided to a processing line. An adhesive is introduced throughout the thickness of the core. Then the core is impregnated with a super absorbent polymer by blowing a stream of super absorbent polymer and air onto the core at a sufficiently high velocity to cause the super absorbent polymer to penetrate the surface of the core. The super absorbent polymer is distributed uniformly throughout the cross-section of the non-woven core and immobilized by the adhesive. Alternatively, the super absorbent polymer is blown into a non-woven core without adhesive and immobilized by a fiber matrix in the non-woven core.

### TECHNICAL FIELD

The present invention relates generally to personal hygiene products and, more particularly, to a process for uniformly impregnating a non-woven core with super absorbent polymer (powder, particles, or both powder and particles) throughout the thickness of the non-woven core.

### BACKGROUND OF THE INVENTION

Super absorbent polymers (SAP's) are synthetic cross-linked polymer materials that are capable of absorbing many times their own weight in liquids such as body exudates. Commercially, SAP's are widely used in personal hygiene products such as diapers and sanitary napkins. The SAP material is distributed typically on or in a matrix (i.e., a core) of natural or synthetic fibers. Because SAP's are highly cross-linked, it is difficult to put them into solution. Accordingly, SAP's are typically used in the form of powders, fibers, or granular particles (i.e., discrete units).

SAP's in these forms are difficult to contain during manufacturing and use, posing potential health risks as well as increasing fabrication costs. One approach to SAP containment is to disperse the SAP in a solid matrix and fix it in place by embossing or calandering. Another approach known in the art is to disperse SAP and fibers together to incorporate the SAP into a solid matrix. These processes suffer from several deficiencies. SAP can be lost during or after the fabrication process by falling through the matrix or dusting off before it is affixed. Further, these processes increase the manufacturing costs due to increased steps and SAP losses. Still further, these processes may not provide a satisfactory distribution of the SAP in the core.

SAP materials have a natural tendency to agglomerate or clump which can adversely effect their absorption capacity. Also, poor SAP distribution can cause gel-blocking: swollen SAP material can block liquid from penetrating into the core preventing fluid from reaching underlying SAP material and adversely affecting the absorption capacity of the composite.

One proposed solution to the SAP distribution problem is described in U.S. Pat. No. 5,419,995 issued to Ehrhardt et al. A process is disclosed in which a matrix material (e.g., various esters and copolymers of esters) is solvated and mixed with particles of SAP along with plasticizers to form a stable suspension. The suspension is then de-solvated to form a matrix material with SAP particles uniformly distributed throughout. This process allows, however, for very limited choices of core material and precludes the use of commercially available pre-fabricated core material. In addition, this process requires the use of specialized processing equipment to create the desired mixture and to de-solvate the mixture. This equipment is not typically available in personal hygiene product manufacturing facilities. Also, the distributed SAP particles can fall through the core. Yet another problem with this process is that it cannot provide a core having a varying thickness, as is desirable in some personal hygiene products.

U.S. Pat. No. 6,071,549 issued to Hansen is directed to binder-treated fibrous webs and products. Various materials are disclosed for use as binders that are capable of forming bonds with the fibers as well as the particles of SAP used to increase the absorbency of various products. A non-woven fibrous mass is formed and a liquid binder is added to the fibers; the binder is capable of forming bonds with the particles of interest. Hansen does not disclose or suggest, however, a process for uniformly distributing and binding SAP particles throughout the thickness of an existing core.

Thus, there is an ongoing need for a manufacturing process that uniformly distributes SAP in the absorbent composite core used in absorbent articles. Moreover, there is a continuing need to improve the absorbent efficacy (including fluid acquisition rates and fluid retention capacities) of absorbent articles incorporating SAP. It is especially desirable to provide absorbent articles of variable thicknesses consistent with such absorbent efficacy.

Therefore, an object of the present invention is to provide the absorbent cores of absorbent articles with uniformly distributed SAP. Another object is to provide a manufacturing process for absorbent cores that uses equipment typically available in personal hygiene product manufacturing facilities. A related object is to permit wide latitude in choosing the core material, especially allowing the use of commercially available pre-fabricated core material, used in the absorbent core. Another related object is to prevent the loss of SAP during or after the manufacturing process. Still another object of the present invention is to provide absorbent articles using an economical process with minimal process steps. Yet another object of the present invention is to provide absorbent articles of variable thicknesses that meet or exceed the absorbent efficacy of conventional absorbent articles.

### SUMMARY OF THE INVENTION

To meet these and other objects, and in view of its purposes, the present invention provides a process for making a SAP-impregnated non-woven absorbent core for personal hygiene products. It should be understood, however that not every embodiment disclosed herein is intended to achieve each objective listed above. Rather, each embodiment is intended to achieve one or more of the listed objectives.

The SAP is essentially uniformly distributed across the cross-section of the non-woven core. In one embodiment of the present invention, a non-woven core is provided and an adhesive is applied throughout the thickness of the core. SAP powder, fibers, or particles are then blown into the substrate at high velocity so as to penetrate through the surface layer into the interior of the core, where the SAP is immobilized by the adhesive. In an alternative embodiment of the present invention, SAP is blown into the substrate without adhesive and immobilized by the matrix of the substrate.

Exemplary techniques for applying the adhesive include: (a) an atomized spray with vacuum applied to the opposite face of the substrate; and (b) an adhesive bath dip and squeeze-out. It may also be possible to use a blown hot melt spray either with a vacuum or with a high-volume airflow to apply the adhesive. Regardless of the technique used, the resulting core contains essentially uniformly distributed adhesive along the cross-sectional thickness of the substrate. The applied adhesive prevents subsequently applied SAP from falling through the core or migrating during shipping and handling, maintaining a uniform distribution of the SAP, thereby enhancing performance of the composite core substrate.

The SAP is mixed with high-velocity air and blown onto the surface of the core such that it penetrates into the core. The SAP and high-velocity air can be mixed in a nozzle, such as those used, for example, in sand blasting processes. Alternatively, the SAP may be introduced into a high velocity air stream. The air velocity controls the penetration. The air velocity can be controllably varied to achieve the desired SAP penetration profile to provide a uniform distribution of SAP throughout the thickness of the core.

The adhesive is cured within a short time of providing adhesive in the core, preferably within seconds. In one embodiment of the present invention, the high-velocity air is heated to accelerate curing of the adhesive as the SAP is blown into the core and comes into contact with the adhesive.

The present invention also relates to absorbent articles comprising the absorbent composite core manufactured by the process according to the present invention. The absorbent articles may include, for example, feminine hygiene articles and diapers. Other absorbent articles may be improved, however, by incorporating the absorbent composite core of the present invention.

It should be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1A is a cross-section illustration of a non-woven core;

FIG. 1B is a cross-section illustration of the non-woven core with adhesive introduced into the core;

FIG. 1C is cross-section illustration of the non-woven core with adhesive introduced into the core and SAP uniformly distributed throughout the core according to the present invention;

FIG. 2A is an apparatus suitable for use in the process for uniformly impregnating a non-woven core with super absorbent polymer (powder, particles, or both powder and particles) throughout the thickness of the non-woven core according to one embodiment of the present invention;

FIG. 2B is an apparatus suitable for use in the process for uniformly impregnating a non-woven core with super absorbent polymer (powder, particles, or both powder and particles) throughout the thickness of the non-woven core according to an alternative embodiment of the present invention;

FIG. 3 is an absorbent article in the form of a sanitary napkin according to the present invention;

FIG. 4 is a cross-section view along the line 4-4 of FIG. 3; and

FIG. 5 is an absorbent article in the form of a diaper according to the present invention.

### DETAILED DESCRIPTION OF THE INVENTION

Referring now to the drawing, in which like reference numbers refer to like elements throughout, the present invention provides a process for uniformly impregnating a non-woven core with super absorbent polymer (SAP) (in the form of powder, particles, or both powder and particles) throughout the thickness of the non-woven core. In one embodiment of the present invention, adhesive is introduced throughout the thickness of a core, and a mixture of SAP particles and air is blown onto the core at a high velocity, such that the SAP particles are uniformly distributed throughout the thickness of the core and immobilized by the adhesive. This process is economical because it can use existing equipment available in many personal hygiene product manufacturing facilities.

1. Providing A Non-Woven Core

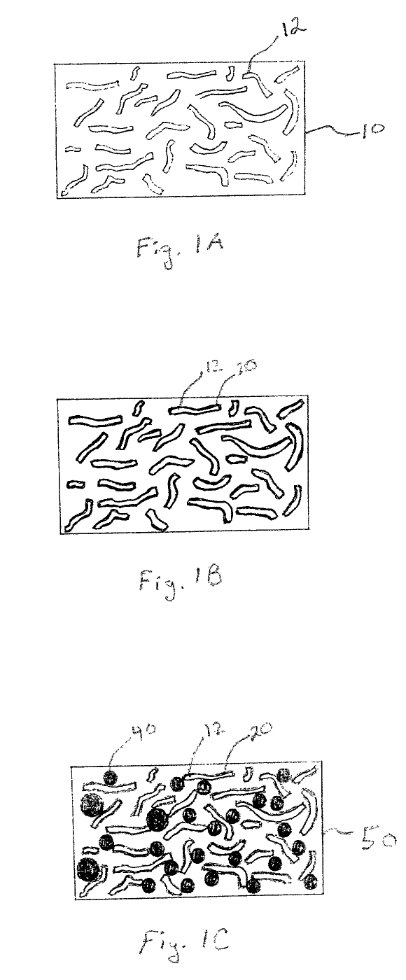

As illustrated in FIG. 1A, the process of the present invention begins by providing a non-woven core 10. Non-woven core 10 comprises a matrix of fibers 12, preferably synthetic fibers that can vary in length according to the desired characteristics of the core. Non-woven core 10 preferably has a thickness of at least 2 millimeters and more preferably has a thickness of between about 5 millimeters and 8 millimeters. In one embodiment, the thickness of non-woven core 10 can vary to provide personal hygiene products with thicker and thinner areas for optimum performance. Non-woven core 10 can be fabricated in advance of its use and stored in rolls with or without adhesive introduced into it. Alternatively, non-woven core 10 can be fabricated, have adhesive introduced into it, and be impregnated with SAP in a continuous process.

More specifically, the preferred non-woven core 10 may comprise a high void-volume matrix of air-bonded synthetic fibers, commonly referred to as “high loft” webs. Matrix fibers, such as polyethylene, polypropylene, or polystyrene are mixed with thermally sensitive bonding fibers (i.e., fibers with a lower melting temperature) and heated air is blown through the matrix to melt at least partially the bonding fibers to adhere the matrix fibers. The non-woven core 10 may alternatively comprise multi-constituent fibers, such as two or more different polymers or a combination of polymer fibers and other hydrophilic fibers. For example, non-woven core 10 may contain other hydrophilic fibers such as are known in the art, including ordinary wood pulp fibers or synthetic polymer fibers, such as polyolefin mono- or multi-component fibers. Alternatively, non-woven core 10 may be constructed of fluff pulp cellulose. Cellulosic fibers are well known and include, for example, digested fibers from softwood, hardwood, or cotton linters, Esparto grass, bagrasse, hemp, and flax. Fibers 12 from other lignaceous and cellulosic fiber sources may also be used. Non-woven core 10 may also contain fibers 12 other than cellulosic fibers.

The non-woven core 10 can be a thermally bonded, or carded, non-woven fabric. Other types of non-woven fabrics known in the art may also be used to form non-woven core 10. Non-woven core 10 typically has a basis weight of about 50 gsm.

2. Introducing an Adhesive

In a preferred embodiment, adhesion between fibers 12 of non-woven core 10 and SAP 40 is achieved with the use of adhesive 20. Therefore, after non-woven core 10 is provided, the next step of the process according to the present invention (assuming that non-woven core 10 is provided without an adhesive) is to introduce adhesive 20 into non-woven core 10. FIG. 1B illustrates the result of this second step of the process according to the present invention. Adhesive 20 can be introduced using any of a variety of techniques. One exemplary technique comprises introducing adhesive 20 from an atomizer with a vacuum drawn through non-woven core 10. Another exemplary technique uses a blown hot melt spray either with a vacuum or with a high-volume airflow to apply adhesive 20. Still another exemplary technique includes the steps of dipping non-woven core 10 in an adhesive bath and squeezing non-woven core 10 to remove excess adhesive 20.

More generally, adhesive 20 may be applied to fibers 12 of non-woven core 10 by any technique for applying solutions to materials, including coating, dumping, pouring, dropping, spraying, atomizing, condensing, or immersing the fibers. The term “applied” means that at least a portion of the surface area of at least most of fibers 12 has an effective amount of adhesive 20 on it to cause adherence of fibers 12 and SAP 40. In other words, adhesive 20 can be applied onto a portion of the surface, or onto the entire surface, of most or all of fibers 12. Preferably, adhesive 20 is coated onto the entire surface of most, preferably all, of fibers 12 so as to enhance the efficiency, strength, and density of the bonds between the SAP particles and the fibers.

Regardless of the particular technique used to introduce adhesive 20 throughout the thickness of non-woven core 10, the volume of adhesive 20 and its distribution throughout the thickness of non-woven core 10 are important aspects of the present invention. Adhesive 20 must be introduced in sufficient volume to immobilize SAP 40 without preventing wicking by the fiber matrix of non-woven core 10. The distribution of adhesive 20 should be uniform throughout the thickness of non-woven core 10 so that SAP particles, fibers, or powder can be uniformly adhered to the fiber matrix throughout the thickness of non-woven core 10.

Adhesive 20 introduced into non-woven core 10 to bond SAP 40 may comprise any of a variety of adhesives suitable for bonding SAP and the core material. In general, adhesive 20 includes substances that can be applied in liquid form to the fibers to allow its presence on the fibers to cause attachment of the SAP and the fibers. Adhesive 20 causes the mechanical or chemical adhesion of the SAP particles and the fibers. As a result, adhesive 20 tends to improve the absorbent (i.e., absorption) capacity and rate of absorption of absorbent members incorporating composites according to this embodiment.

The selection of a particular adhesive will typically depend on the chemical composition of the SAP and the fiber material and can be made by one skilled in the art. Preferably, adhesive 20 is suitable for use in applications involving human contact, for example, disposable absorbent articles. Thus, adhesive 20 should be non-toxic and non-irritating to humans. Mixtures of adhesives may be used.

Several types of adhesives are suitable. Without intending to be bound by theory, it is believed that one type of adhesive 20 causes the polymer material of the SAP particles to adhere to the non-woven fibers by the action of fluid surface tension forces and the entanglement of polymer chains due to external softening. Adhesives of this type include (1) hydrophilic organic solvents, typically low molecular weight alcohols, for example, methanol, ethanol, isopropanol and the like, or polyols, for example, propylene glycol, glycerol and the like; (2) water; (3) volatile hydrophobic organic compounds, for example, hexane, octane, benzene, toluene and the like; and (4) mixtures of these materials. Preferred adhesives of this type are hydrophilic organic solvents, water, and a mixture of such solvents and water. These adhesives particularly tend to predispose the SAP to wetting, such that they tend to improve the absorbent capacity and rate of absorption of the non-woven core 10. More preferably, adhesives of this type are selected from water, glycerol, propylene glycol, and mixtures of these materials.

Other adhesives tend to rely less or not at all on the fluid surface tension forces or the entanglement of polymer chains of swollen SAP particles for adhesion to the fibers. This type of adhesive typically involves mechanical or chemical interaction between the adhesive, fiber, and the SAP particles. For example, the adhesive may form bridges between the SAP and the fibers. This type of adhesive is preferred because it tends to provide stronger attachment between the fibers and SAP. Adhesives of this type include, for example, cationic polyacrylamides, cationic amino-epichlorohydrin adducts, and mixtures of these materials. Such adhesives are preferably employed in an aqueous mixture.

In the most preferred embodiments of the present invention, the adhesive includes water. The presence of water in the adhesive is particularly effective in predisposing the SAP to wetting. The adhesive preferably contains at least about 60% water, by weight of the adhesive, with the balance consisting essentially of at least one non-aqueous adhesive. Non-aqueous adhesives include hydrophilic organic solvents, volatile hydrophobic compounds, cationic polyacrylamides, and cationic amino-epichlorohydrin adducts. The adhesive more preferably contains from about 80% to about 90% water and from about 20% to about 10% of at least one non-aqueous adhesive, based on the total weight of the adhesive. Adhesive 20 most preferably comprises an acrylate which is introduced in an aqueous form.

Depending on the particular adhesive which is selected, adhesion may occur without any additional steps, or may require an additional drying step or reaction step. Because SAP 40 will absorb moisture from the aqueous adhesive, reducing the effectiveness of the SAP, adhesive 20 should be cured as soon after it comes into contact with the SAP as possible. Adhesive 20 can be cured using a heating element or device (not shown) for forcing a stream of heated air over adhesive 20. To reduce moisture absorption by SAP 40, heat is applied immediately following SAP impregnation.

Fibers 12 are typically individualized prior to application of adhesive 20. The term “individualized” means that fibers 12 are mechanically separated such that there is a relatively low level of fiber entanglement, as compared to a bulk fiber source such as a fiber sheet or bale. This mechanical separation can be performed by a variety of methods. Mechanical separation is preferably performed by a method in which knot formation and fiber damage are minimized. For example, a three-stage fluffing device can subject a fibrous material to a combination of mechanical impact, mechanical agitation, air agitation, and a limited amount of air drying to create a substantially knot-free fluff. Other applicable methods for individualizing fibers 12 include, but are not limited to, treatment with a blender and tangentially contacting the fibers with a rotating disk refiner or wire brush. Preferably, an air stream is directed toward fibers 12 to aid in separating the fibers.

Adhesive 20 is preferably applied to fibers 12 in an amount of from about 0.10% to about 25% of the weight of fibers 12 in the composite, the weight of the fibers being on a bone-dry basis. More preferably, adhesive 20 is used in an amount of about 10% to about 15% of the weight of the fibers in the composite. The phrase “bone dry basis” means the actual weight of the fibers less the weight of any moisture or other volatiles which may be present in the fibers. For example, a 100 gram sample of fibers 12 containing 10% moisture has a fiber weight, on a bone-dry basis, of 90 grams.

If adhesive 20 includes water, care must be taken to avoid excessive swelling of fibers 12. It is believed that, when such swelling occurs, the fiber surfaces become relatively round as compared to a substantially flat surface in the unswollen condition. As a result, the bonding area between any individual fiber and any individual SAP particle tends to decrease as the fibers swell such that the degree of attachment is lessened. Swelling of fibers 12 is influenced by the amount of water that is applied to the fibers and the amount of time that the fibers are exposed to the water. Control of these conditions so as to avoid excessive fiber swelling will be readily understood by one skilled in the art. Typically, the contact time between fibers 12 and aqueous adhesive 20 is kept to a very short time, e.g., from about five minutes to a few seconds, by the addition of heat to dry or cure the mixture. The mixture is typically subjected to temperatures of about 100° C. to about 177° C., preferably from about 121° C. to about 177° C., for this purpose.

3. Distributing Uniformly A Super Absorbent Polymer

After applying adhesive 20 onto fibers 12 of non-woven core 10, and while adhesive 20 is still in liquid form, the SAP particles and non-woven fibers 12 are physically associated together such that a substantial number of fibers 12 adhere to SAP 40. Thus, the SAP particles and fibers 12 are brought together and contacted. The physical association of the SAP particles and fibers 12 preferably involves physically contacting fibers 12 and SAP 40 at the surface of fibers 12 having adhesive 20.

While the SAP particles and fibers 12 are physically associated together, adhesive 20 is dried or reacted so as to cause adherence between SAP 40 and fibers 12. Depending on the chemical compositions of the particular adhesive 20, SAP 40, and material of non-woven core 10 that are selected, reaction of adhesive 20 may involve reaction of the adhesive itself, for example polymerization, or reaction of adhesive 20 with the polymer material of SAP 40, with fibers 12 of non-woven core 10, or both.

Depending on the particular adhesive being used, the drying or reacting may occur without any additional step or may involve thermal heating or irradiation (e.g., ultraviolet radiation, gamma radiation, or x-radiation). The particular conditions required to dry or react adhesive 20 will depend on the chemical compositions of the particular adhesive, SAP, and fiber material that are selected. Typically, the drying or reaction is caused by heating to a temperature of from about 100° C. to about 177° C., preferably from about 121° C. to about 177° C., for a time period of from about a few seconds to about 5 minutes.

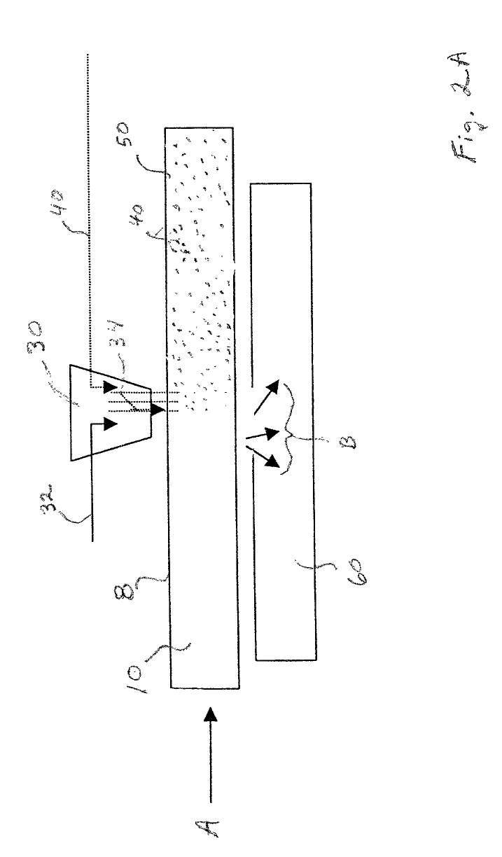

In a preferred embodiment according to the present invention, the manufacturing process line shown in FIG. 2A advances non-woven core 10 from left to right in the direction of arrow “A.” Non-woven core 10 is shown in FIG. 2A with adhesive 20 already introduced throughout its thickness. Non-woven core 10 with adhesive 20 introduced throughout its thickness is advanced proximate a high-velocity air nozzle 30. SAP 40 is mixed into a stream of air 32 and directed by high-velocity air nozzle 30 onto the surface 8 of non-woven core 10 as a high-velocity stream 34 comprising a mixture of air and SAP 40. At a sufficiently high velocity, much of high-velocity stream 34 will penetrate surface 8 of non-woven core 10 impregnating SAP 40 into non-woven core 10. The depth of penetration for any specific particle or grain of SAP 40 will vary due to interactions with fibers 12 in non-woven core 10, the interaction with other particles or grains of SAP 40, the interactions with adhesive 20, and the interaction of the fiber matrix with high-velocity stream 34. Alternatively, as shown in FIG. 2B, the super absorbent polymer may be introduced into a high-velocity stream of air after the high-velocity stream leaves high-velocity air nozzle 30.

The resulting SAP-impregnated core 50 will have SAP 40 distributed throughout the thickness of non-woven core 10 as illustrated in FIG. 1C. SAP 40 is more uniformly distributed throughout the thickness of non-woven core 10 if the velocity of high-velocity stream 34 is maintained. Accordingly, a vacuum device 60 is preferably disposed proximate non-woven core 10 opposite high-velocity nozzle 30. Vacuum device 60 draws a vacuum through non-woven core 10, in the direction of arrows “B,” helping to maintain the velocity of high-velocity stream 34, thereby providing a uniform distribution of SAP 40 throughout the thickness of non-woven core 10. SAP 40 adheres to adhesive 20, immobilizing the SAP.

In one embodiment of the present invention, the air in high-velocity stream 34 is heated. The air can be heated either in combination with other curing steps or in place of other curing steps. The step of heating the air in high-velocity stream 34 will cause the curing process for adhesive 20 to begin at the same time that SAP 40 contacts adhesive 20.

The SAP material may be in the form of powder, fibers, particles, or a mixture thereof. The term “particles” means that the SAP is in the form of discrete units. The particles can comprise granules, pulverulents, spheres, flakes, or fibers. Thus, the SAP particles can have any desired shape such as cubic, rod-like, polyhedral, spherical, rounded, angular, irregular, randomly sized irregular shapes (e.g., pulverulent products of a grinding or pulverizing step) or shapes having a large greatest dimension-to-smallest dimension ratio like needles, flakes, and the like. Although the particles may have sizes varying over a wide range, the particle size typically ranges from about 1 micron to about 2,000 microns in diameter or cross-section. The particles of absorbent SAP material may optionally be surface treated.

Although the selection of the SAP material is not critical to the present invention, the SAP material is typically a water-insoluble material capable of absorbing and retaining even under moderate pressures large amounts of aqueous fluids (such as water and body exudates) in comparison to its own weight. It may be derived from a first hydrophilic monomer, which is acrylic acid or a water-soluble sodium salt of acrylic acid, and a second hydrophilic monomer which can be a soluble salt of beya-acryoxypropionic acid. The superabsorbent polymerization conditions provide high molecular weight, lightly cross-linked, polymer compositions having a low soluble fraction. A suitable SAP is ASAP-2102.

Preferred absorbent SAP materials exhibit a high absorptive capacity. Absorptive capacity refers to the capacity of a given polymer material to absorb liquids with which it comes into contact, and can vary significantly with the nature of the liquid being absorbed and with the manner in which the liquid contacts the polymer material. For purposes of this invention, Absorptive Capacity is defined in terms of the amount of Synthetic Urine absorbed by any given polymer material in terms of grams of Synthetic Urine per gram of polymer material. Preferred absorbent SAP materials of the present invention are those which have an Absorptive Capacity of at least about 20 grams, more preferably at least about 25 grams, of Synthetic Urine per gram of polymer material. Typically, the polymer materials have an Absorptive Capacity of from about 40 to about 70 grams of Synthetic Urine per gram of polymer material.

4. Immobilizing Super Absorbent Polymer Without Adhesive

In an alternative embodiment, no adhesive is distributed throughout the non-woven core. Instead, Powder, fibers, or particles of super absorbent polymer are blown into a non-woven core comprising a matrix of fibers and trapped by the matrix of fibers. As in the embodiment described above, the process of the present invention begins by providing a non-woven core 10. Non-woven core 10 may again comprise a carded or air-laid matrix of fibers 12, preferably synthetic fibers that can vary in length according to the desired characteristics of the core. Alternatively, other hydrophilic fibers, such as cellulosic fibers, or multi-constituent fibers may be used to fabricate non-woven core 10. Non-woven core 10 can be fabricated in advance of its use and stored in rolls. In this embodiment, the fiber density and super absorbent polymer shape and size must be selected to ensure that the fiber matrix of the non-woven core 10 retains the super absorbent polymer. The super absorbent polymer, therefore preferably comprises particles with a diameter greater than the median pore size of the fiber matrix or particles of sufficient length to be retained by the fiber matrix of the non-woven core.

Referring again to FIG. 2A, a non-woven core 10 (without adhesive) is advanced proximate a high-velocity air nozzle 30. SAP 40 is mixed into a stream of air 32 and directed by high-velocity air nozzle 30 onto the surface 8 of non-woven core 10 as a high-velocity stream 34 comprising a mixture of air and SAP 40. At a sufficiently high velocity, much of high-velocity stream 34 will penetrate surface 8 of non-woven core 10 impregnating SAP 40 into non-woven core 10. The depth of penetration for any specific particle or grain of SAP 40 will vary due to interactions with fibers 12 in non-woven core 10, the interaction with other particles or grains of SAP 40, and the interaction of the fiber matrix with high-velocity stream 34. As in the embodiment described above and shown in FIG. 2B, the super absorbent polymer can alternatively be introduced into a high-velocity air stream.

The resulting SAP-impregnated core 50 will have SAP 40 distributed throughout the thickness of non-woven core 10 as illustrated in FIG. 1C. SAP 40 is more uniformly distributed throughout the thickness of non-woven core 10 if the velocity of high-velocity stream 34 is maintained. Accordingly, a vacuum device 60 is preferably disposed proximate non-woven core 10 opposite high-velocity nozzle 30. Vacuum device 60 draws a vacuum through non-woven core 10, in the direction of arrows “B,” helping to maintain the velocity of high-velocity stream 34, thereby providing a uniform distribution of SAP 40 throughout the thickness of non-woven core 10. The high-velocity stream 34 carries the SAP 40 into fiber matrix where it becomes trapped in pores smaller than the SAP, immobilizing the SAP.

5. Manufacturing Articles Using Impregnated Core

The impregnated core 50 (comprising non-woven core 10 having SAP 40 uniformly distributed throughout the core and retained by adhesive 20) of the present invention is particularly useful in absorbent members for disposable absorbent articles. Impregnated core 50 of the present invention is particularly useful as the absorbent core of disposable absorbent articles. In general, impregnated core 50 may be used in the same manner for which conventional absorbent materials have been used. Impregnated core 50 provides certain advantages, however, over conventional particulate absorbent materials.

In particular, impregnated core 50 has uniform SAP distribution which reduces clumping or agglomeration of SAP 40 and enhances the absorbent capacity of the core. Also, in impregnated core 50, SAP 40 may be bonded to fibers 12 within the core reducing SAP loss. SAP loss can reduce the absorbent capacity of a core and cause adverse health conditions during manufacturing and use of an absorbent product. Conservation of SAP 40 (at least in the embodiment employing adhesive) also renders the manufacture of impregnated core 50 economical, as do the minimal number of steps and the compatibility of standard equipment required to manufacture impregnated core 50. Impregnated core 50 also is compatible with (i.e., permits choice of) a wide range of other component materials. Finally, impregnated core 50 permits incorporation of a core of varying thickness in disposable absorbent articles.

It should be understood, however, that impregnated core 50 and absorbent members containing impregnated core 50 can be used for many purposes in many other fields of use. For example, the impregnated core 50 of the present invention can be used for packing containers, drug delivery devices, wound cleaning devices, burn treatment devices, ion exchange column materials, construction materials, agricultural or horticultural materials such as seed sheets or water-retentive materials, and industrial uses such as sludge or oil dewatering agents, materials for the prevention of dew formation, desiccants, and humidity control materials.

The term “absorbent article” refers to devices which absorb and contain body exudates, and more specifically, refers to devices which are placed against the skin of a wearer to absorb and contain the various exudates discharged from the body. The term “disposable” describes absorbent articles which are not intended to be laundered or otherwise restored or reused as an absorbent article after a single use. Examples of disposable absorbent articles include feminine hygiene garments such as sanitary napkins and pantiliners, diapers, incontinence briefs, diaper holders, training pants, and the like.

Disposable absorbent articles typically comprise a liquid-pervious top sheet, a liquid-impervious back sheet joined to the top sheet, and an absorbent core positioned between the top sheet and the back sheet. Disposable absorbent articles and their components, including the top sheet, back sheet, absorbent core, and any individual layers of these components, have a body surface and a garment surface. The “body surface” means that surface of the article or component which is intended to be worn toward or adjacent to the body of the wearer; the “garment surface” is on the opposite side and is intended to be worn toward or placed adjacent to the undergarments of the wearer when the disposable absorbent article is worn. The absorbent article including impregnated core 50 can include other absorbent components that are often used in absorbent articles, for example, a dusting layer, a wicking or acquisition layer, or a secondary top sheet for increasing the comfort of the wearer.

The top sheet is preferably compliant, feels soft, and does not irritate the skin. Further, the top sheet is liquid pervious, permitting liquids (e.g., menses or urine) to readily penetrate through its thickness. A suitable top sheet may be manufactured from a wide range of materials such as woven and non-woven materials (e.g., a non-woven web of fibers); polymer materials such as thermoplastic films having apertures, plastic films having apertures, and hydro-formed thermoplastic films; porous foams; reticulated foams; reticulated thermoplastic films; and thermoplastic scrims. Suitable woven and non-woven materials can be comprised of natural fibers (e.g., wood or cotton fibers), synthetic fibers (e.g., polymeric fibers such as polyester, polypropylene, or polyethylene fibers), or from a combination of natural and synthetic fibers. When the top sheet comprises a non-woven web, the web may be manufactured by a wide number of known techniques. For example, the web may be spun-bonded, carded, wet-laid, melt-blown, hydro-entangled, combinations of the above, or the like.

The back sheet is impervious to liquids (e.g., menses and urine) and is preferably manufactured from a thin plastic film, although other flexible liquid-impervious materials may also be used. The term “flexible” refers to materials which are compliant and will readily conform to the general shape and contours of the human body. The back sheet prevents the exudates absorbed and contained in impregnated core 50 from wetting articles which contact the absorbent article such as bed sheets, pants, pajamas, and undergarments. Thus, the back sheet may comprise a woven or non-woven material, polymer films such as thermoplastic films of polyethylene or polypropylene, or composite materials such as a film-coated non-woven material. A suitable back sheet is a polyethylene film having a thickness of from about 0.012 mm (0.5 mil) to about 0.051 mm (2.0 mils). The back sheet is preferably embossed or matte-finished to provide a more cloth-like appearance. Further, the back sheet may permit vapors to escape from impregnated core 50 (i.e., the back sheet is breathable) while still preventing exudates from passing through the back sheet. The size of the back sheet is dictated by the size of impregnated core 50 and the exact absorbent article design selected.

The back sheet and the top sheet are positioned adjacent the garment surface and the body surface, respectively, of impregnated core 50. Impregnated core 50 is preferably joined with the top sheet, the back sheet, or both in any manner such as those well known in the art. Embodiments of the present invention are envisioned, however, in which portions of the entire impregnated core 50 are unattached to either the top sheet, the back sheet, or both.

For example, the back sheet or the top sheet may be secured to impregnated core 50 or to each other by a uniform continuous layer of adhesive, a patterned layer of adhesive, or an array of separate lines, spirals, or spots of adhesive. Alternatively, the attachment may comprise heat bonds, pressure bonds, ultrasonic bonds, dynamic mechanical bonds, or any other suitable attachment mechanism or combinations of these mechanisms as are known in the art.

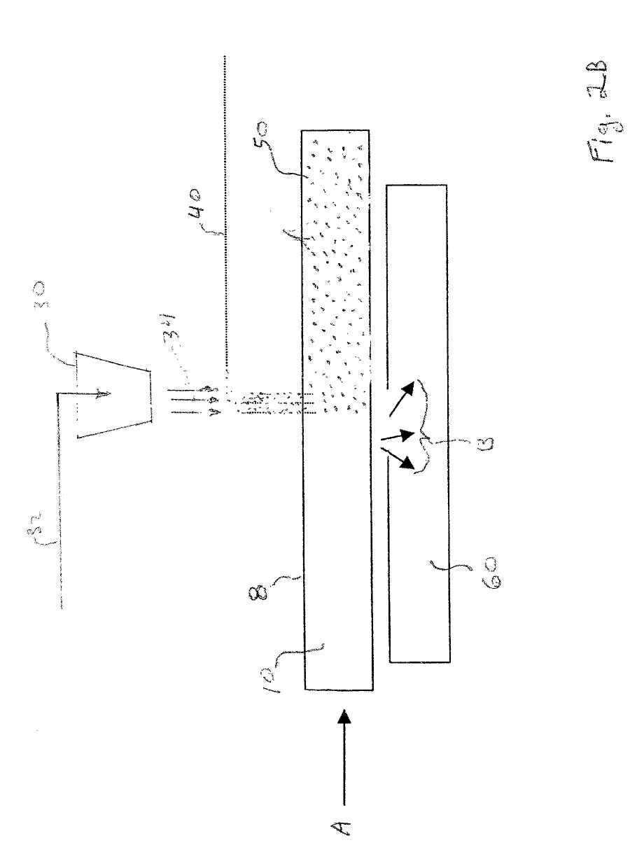

A preferred embodiment of a unitary disposable absorbent article of the present invention is the catamenial pad, sanitary napkin 300, shown in FIG. 3. The term “sanitary napkin” refers to an absorbent article which is worn by females adjacent to the pudendal region, generally external to the urogenital region, and which is intended to absorb and contain menstrual fluids and other vaginal discharges from the body (e.g., blood, menses, and urine). Interlabial devices which reside partially within and partially external of the vestibule are also within the scope of this invention. It should be understood, too, that the present invention is also applicable to other feminine hygiene or catamenial pads such as pantiliners, or other absorbent articles such as incontinence pads including diapers, and the like.

FIG. 3 is a plan view of sanitary napkin 300 of the present invention in its flat-out state with portions of the structure being cut-away to more clearly show the construction of sanitary napkin 300 and with the portion of sanitary napkin 300 which faces or contacts the wearer oriented toward the viewer. Sanitary napkin 300 has two surfaces, a body-contacting surface 302 or “body surface” and a garment surface 304. Sanitary napkin 300 is shown in FIG. 3 as viewed from its body surface. The body surface is intended to be worn adjacent to the body of the wearer while the garment surface is on the opposite side and is intended to be placed adjacent to the undergarments when sanitary napkin 300 is worn. As shown in FIG. 3, sanitary napkin 300 preferably comprises a central absorbent body 310 and an undergarment protection system 350.

Central absorbent body 310 comprises a liquid pervious top sheet 320, a liquid impervious back sheet 330 joined with top sheet 320, and impregnated core 50 positioned between top sheet 320 and back sheet 330. FIG. 3 also shows that central absorbent body 310 has a periphery which is defined by the outer edges of central absorbent body 310 in which the longitudinal edges are designated 312 and the end edges are designated 314. Central absorbent body 310 further has a longitudinal centerline 316 and a transverse centerline 318. The term “longitudinal” refers to a line, axis, or direction in the plane of the absorbent article that is generally aligned with (e.g., approximately parallel to) a vertical plane which bisects a standing or upright wearer into left and right body halves when the absorbent article is worn. The terms “transverse” or “lateral” are interchangeable and refer to a line, axis, or direction which lies within the plane of the absorbent article that is generally perpendicular to the longitudinal direction. As shown in FIG. 3, impregnated core 50 has a body surface 342, a garment surface 344, side edges 346, and end edges 348.

In general, the construction of top sheet 320, back sheet 330, and impregnated core 50 is as described above. FIG. 3 shows a preferred embodiment of sanitary napkin 300 in which top sheet 320 and back sheet 330 have length and width dimensions generally larger than those of impregnated core 50. Top sheet 320 and back sheet 330 extend beyond the edges of impregnated core 50 to thereby form portions of the periphery. In a preferred embodiment of sanitary napkin 300 of the present invention, the body surface of top sheet 320 is hydrophilic to help liquid transfer through top sheet 320 faster than if the body surface were not hydrophilic so as to diminish the likelihood that menstrual fluid will flow off top sheet 320 rather than flowing into and being absorbed by impregnated core 50. In a preferred embodiment, top sheet 320 can be made hydrophilic by treating it with a surfactant.

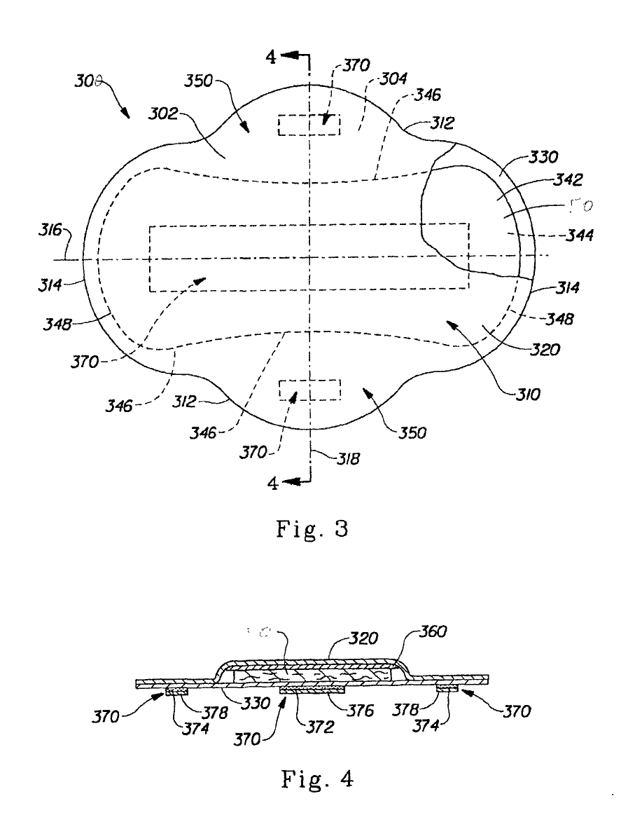

In the preferred embodiment of the present invention shown in FIG. 4, an acquisition component 360 (or components) may either be positioned between top sheet 320 and impregnated core 50, or comprise the bottom surface of a composite top sheet. The acquisition component may serve several functions. These functions include improving wicking of exudates over and into impregnated core 50. The improved wicking of exudates is important because it provides a more even distribution of the exudates throughout impregnated core 50 and allows sanitary napkin 300 to be made relatively thin. The wicking may encompass the transportation of liquids in one, two, or all directions (i.e., in the x-y plane or in the z-direction). Acquisition component 360 may be comprised of several different materials such as non-woven or woven webs of synthetic fibers including polyester, polypropylene, or polyethylene; natural fibers including cotton or cellulose; blends of such fibers; or any equivalent materials or combinations of materials. In a preferred embodiment, acquisition component 360 may be joined with top sheet 320 by any of the conventional mechanisms for joining webs together, most preferably by fusion bonds.

In use, sanitary napkin 300 can be held in place by any attachment mechanism 370 well known for such purposes. Preferably, sanitary napkin 300 is placed in the undergarment or panty of the user and secured by a fastener such as an adhesive. The adhesive secures sanitary napkin 300 in the crotch portion of the undergarment. Thus, a portion or all of garment surface 304 of sanitary napkin 300 may be coated with adhesive. For the preferred embodiment of the present invention shown in FIG. 3, a portion is disposed on both central absorbent body 310 and undergarment protection system 350 of sanitary napkin 300. That portion of the adhesive disposed on central absorbent body 310 is identified as the pad adhesive 372 and that portion disposed on undergarment protection system 350 is identified as the flap adhesive 374 depending on which element of undergarment protection system 350 the adhesive is disposed.

Any adhesive or glue used in the art for such purposes can be used for the adhesive, with pressure-sensitive adhesives being preferred. The pressure-sensitive adhesive is typically covered with a removable release liner in order to keep the adhesive from adhering to a surface other than the crotch portion of the undergarment prior to use. These structures are identified as the pad release liner 376 and the flap release liner 378 in FIG. 4. Any commercially available release liners commonly used for such purposes can be adopted. Sanitary napkin 300 of the present invention is used by removing the release liner and placing sanitary napkin 300 in an undergarment so that the adhesive contacts the undergarment. The adhesive maintains sanitary napkin 300 in its position within the undergarment during use.

Sanitary napkin 300 of the present invention may further comprise side flaps as undergarment protection system 350. The flaps serve at least two purposes. First, the flaps help to prevent soiling of the body and underwear by menstrual fluid, preferably by forming a double-wall barrier along the edges of the undergarment. Second, the flaps are preferably provided with flap adhesive 374 on their garment surface so that they can be folded back under the undergarment and attached to the garment-facing side of the undergarment or to each other. In this way, the flaps keep sanitary napkin 300 properly positioned in the undergarment. The flaps can be constructed of various materials, including materials similar to the top sheet and back sheet.

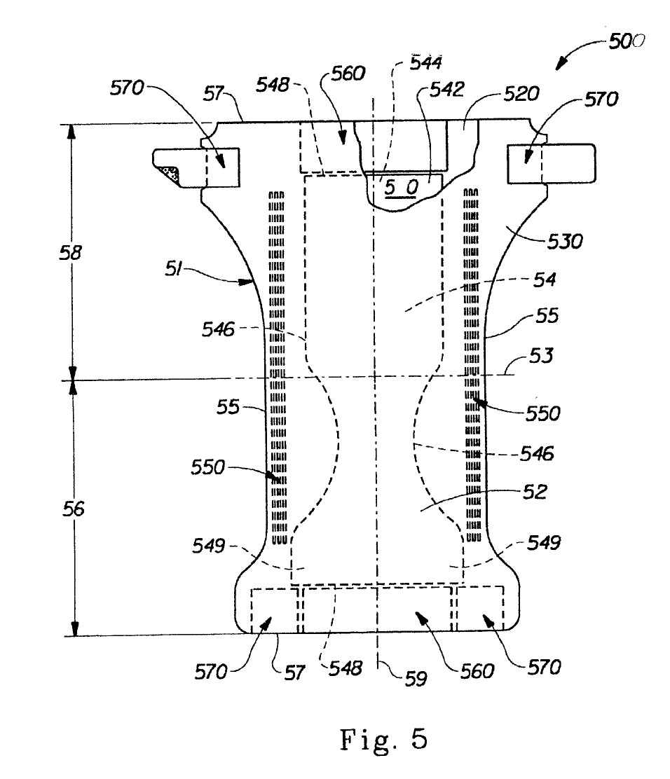

Another disposable absorbent article in which impregnated core 50 may be used is a diaper. The term “diaper” refers to an absorbent article generally worn by infants and incontinent persons that is worn about the lower torso of the wearer. FIG. 5 is a plan view of the diaper 500 of the present invention in its flat-out, uncontracted state (i.e., with elastic-induced contraction pulled out) with portions of the structure being cut-away to more clearly show the construction of diaper 500 and with the portion of diaper 500 which faces away from the wearer (the outer surface) oriented toward the viewer. As shown in FIG. 5, diaper 500 preferably comprises a liquid-pervious top sheet 520; a liquid-impervious back sheet 530 joined with top sheet 520; impregnated core 50 positioned between top sheet 520 and back sheet 530, impregnated core 50 having a garment-facing surface 542, a body-facing surface 544, side edges 546, waist edges 548, and ears 549. Diaper 500 preferably further comprises elasticized leg cuffs 550; an elastic waist feature multiply designated as 560; and a fastening system generally multiply designated as 570.

Diaper 500 is shown in FIG. 5 to have an outer surface 52, an inner surface 54 opposed to outer surface 52, a first waist region 56, a second waist region 58, and a periphery 51 which is defined by the outer edges of diaper 500 in which the longitudinal edges are designated 55 and the end edges are designated 57. (Although the skilled artisan will recognize that a diaper is usually described in terms of having a pair of waist regions and a crotch region between the waist regions, in this application, for simplicity of terminology, diaper 500 is described as having only waist regions including a portion of the diaper which would typically be designated as part of the crotch region.) Inner surface 54 of diaper 500 comprises that portion of diaper 500 which is positioned adjacent to the body during use (i.e., inner surface 54 generally is formed by at least a portion of top sheet 520 and other components that may be joined to top sheet 520). Outer surface 52 comprises that portion of diaper 500 which is positioned away from the body (i.e., outer surface 52 generally is formed by at least a portion of back sheet 530 and other components that may be joined to back sheet 530). First waist region 56 and second waist region 58 extend, respectively, from end edges 57 of periphery 51 to the lateral centerline 53 of diaper 500. FIG. 5 also shows the longitudinal centerline 59.

FIG. 5 shows a preferred embodiment of diaper 500 in which top sheet 520 and back sheet 530 have length and width dimensions generally larger than those of impregnated core 50. Elasticized leg cuffs 550 and back sheet 530 extend beyond the edges of impregnated core 50 to thereby form periphery 51 of diaper 500. Diapers of the present invention can have a number of well-known configurations.

Top sheet 520 of diaper 500 is preferably made of a hydrophobic material to isolate the skin from liquids which have passed through top sheet 520 and are contained in impregnated core 50 (i.e., to prevent rewet). If top sheet 520 is made of a hydrophobic material, at least the upper surface of top sheet 520 is treated to be hydrophilic so that liquids will transfer through top sheet 520 more rapidly. This feature diminishes the likelihood that body exudates will flow off top sheet 520 rather than being drawn through top sheet 520 and being absorbed by impregnated core 50. Top sheet 520 can be rendered hydrophilic by treating it with a surfactant.

In a preferred embodiment of diaper 500, back sheet 530 has a modified hourglass shape extending beyond impregnated core 50 a minimum distance of about 1.3 cm to about 6.4 cm (about 0.5 inch to about 2.5 inches) around the entire diaper periphery. Impregnated core 50 may take on any size or shape that is compatible with diaper 500. One preferred embodiment of diaper 500 has an asymmetric, modified T-shaped impregnated core 50 having ears in the first waist region but a generally rectangular shape in the second waist region. Preferably, impregnated core 50 will be included (perhaps in combination with other elements) in a component which functions primarily to retain or store fluids, as opposed to acquiring or distributing fluids (typically referred to as the storage layer or storage core).

In a preferred embodiment, diaper 500 further comprises elasticized leg cuffs 550 for providing improved containment of liquids and other body exudates; an elastic waist feature 560 that provides improved fit and containment; and a fastening system 570 which forms a side closure which maintains first waist region 56 and second waist region 58 in an overlapping configuration such that lateral tensions are maintained around the circumference of diaper 500 to maintain the diaper on the wearer. Diaper 500 may also comprise elasticized side panels (not shown) in waist regions 56 and 58 to provide an elastically extensible feature that provides a more comfortable and contouring fit and more effective application of diaper 500.

Diaper 500 is preferably applied to a wearer by positioning one of the waist regions of the diaper, preferably second waist region 58, under the back of the wearer and drawing the remainder of the diaper between the legs of the wearer so that the other waist region, preferably first waist region 56, is positioned across the front of the wearer. The fastening system is then applied to effect a side closure.

Impregnated core 50 of the present invention is useful in pantiliners and in training pants. Other disposable absorbent articles for which impregnated core 50 of the present invention is useful are incontinence articles. The term “incontinence article” refers to pads, undergarments (pads held in place by a suspension system of some type, such as a belt or the like), inserts for absorbent articles, capacity boosters for absorbent articles, briefs, bed pads, and the like regardless of whether they are worn by adults or other incontinent persons.

Although illustrated and described above with reference to certain specific embodiments, the present invention is nevertheless not intended to be limited to the details shown. Rather, various modifications may be made in the details within the scope and range of equivalents of the claims and without departing from the spirit of the invention. The impregnated core may also (optionally) include, for example, an odor neutralizer such as baking soda.

What is claimed:

1. A process for forming an absorbent composite, comprising the step of:
blowing a stream of super absorbent polymer and air onto a non-woven core at a sufficiently high velocity to cause the super absorbent polymer to penetrate the surface of the core, wherein the super absorbent polymer is distributed substantially uniformly throughout the cross-section of the non-woven core and immobilized.

2. The process of claim 1 wherein the non-woven core has a thickness of at least 2 millimeters and comprises a matrix of synthetic fibers.

3. The process of claim 1 wherein the non-woven core has a thickness of between about 5 millimeters and 8 millimeters and comprises a matrix of synthetic fibers.

4. The process of claim 1 wherein the core comprises a matrix of fibers and the super absorbent polymer is immobilized by the matrix of fibers.

5. The process of claim 1 further comprising, before the step of blowing a stream of super absorbent polymer and air onto a non-woven core, the steps of:
providing the non-woven core; and
introducing an adhesive throughout the thickness of the core;
wherein, after being blown into the core, the super absorbent polymer is immobilized by the adhesive.

6. The process of claim 5 which further includes applying heat to the core to cure the adhesive subsequent to blowing a mixture of super absorbent polymer and air onto the substrate.

7. The process of claim 5 wherein the air in the mixture of super absorbent polymer and air is provided at a sufficient temperature to cure the adhesive while allowing the super absorbent polymer to adhere to the adhesive.

8. The process of claim 5 wherein the core comprises a matrix of synthetic fibers which can be fabricated and stored in rolls in advance of adhesive and super absorbent application, and unrolled for application of the adhesive and super absorbent polymer.

9. The process of claim 5 wherein the adhesive comprises an acrylate which is introduced in an aqueous form.

10. The process of claim 9 wherein the adhesive is introduced throughout the thickness of the core using an atomizer to dispense the adhesive and a vacuum opposite the atomizer to assist in introducing the adhesive throughout the thickness of the core.

11. The process of claim 9 wherein the adhesive is introduced throughout the thickness of the core by dipping the core into an adhesive bath followed by squeezing out excess adhesive.

12. The process of claim 10 wherein the fabrication of the core, the introduction of the adhesive, the distribution of the super absorbent polymer, and the drying of the adhesive are performed in a continuous manufacturing line.

13. The process of claim 11 wherein the fabrication of the core, the introduction of the adhesive, the distribution of the super absorbent polymer, and the drying of the adhesive are performed in a continuous manufacturing line.

14. An apparatus for manufacturing super absorbent composite layers, comprising:
a component configured to feed a core onto a manufacturing line; and
a component configured to blow a mixture of super absorbent polymer and air onto the core at a sufficient velocity to cause the super absorbent polymer to penetrate into the core.

15. The apparatus of claim 14 further comprising a component configured to introduce an adhesive throughout the thickness of the core.

16. A super absorbent composite comprising:
a core having a thickness of at least 2 millimeters and comprising a matrix of synthetic fibers; and
particles of a super absorbent polymer distributed substantially uniformly throughout the thickness of the core, wherein the particles of super absorbent polymer are adhered to the synthetic fibers of the core by an adhesive.

17. The super absorbent composite of claim 16 wherein the thickness of the core is between about 5 millimeters and 8 millimeters.

18. The super absorbent composite of claim 16 wherein the adhesive comprises an acrylate.
